(19) United States
(12) Patent Application Publication
(10) Pub. No.: US 2010/0145863 A1
(43) Pub. Date: Jun. 10, 2010

(54) METHOD AND SYSTEM FOR CREATIVE COLLABORATIVE MARKETPLACES

(75) Inventor: Venkatesh Guru Rao, Arlington, VA (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/331,740

(22) Filed: Dec. 10, 2008

(51) Int. Cl. G06Q 40/00; G06Q 30/00

(52) U.S. Cl. 705/80; 705/37; 705/36 R

(57) ABSTRACT

A method of conducting a multi-level transaction includes receiving a primary call for proposals, publicizing the primary call for proposals, receiving one or more primary bids by a computing system with respect to the primary call for proposals, receiving one or more secondary calls for proposals for each primary bid, receiving one or more secondary bids by the computing system with respect to the one or more secondary calls for proposals, automatically determining an estimated cost of fulfillment for each primary bid, receiving a selection of a primary bid based on at least the estimated costs of fulfillment for the primary bids, and displaying the selection of the primary bid. Each secondary call for proposals includes a job request associated with the primary bid. The estimated cost of fulfillment is based on a cost of fulfillment associated with the primary bid and one or more secondary call costs of fulfillment.

### BACKGROUND

1. Technical Field

This application relates to conducting multi-level transactions in a computing environment. More specifically, the present disclosure relates to systems and methods of conducting a multi-level transaction and determining estimated costs of fulfillments for associated primary bids.

2. Description of Related Prior Art

In the world of auctions and transactions, buyers initiate the process with a call for proposals. These calls for proposals have traditionally led providers/contractors to submit bids in hopes of contracting for the work. Buyers will then select an optimal bid from those submitted. Prior to the use of online marketplaces, this process could be extremely tedious and time-consuming. Further, buyers could select a provider's bid where the provider still had to submit bids to sub-contractors to fully complete the provider's own work, a factor which could affect the overall estimate.

Buyers additionally were unable to identify which sub-contractors were selected, or to know how trustworthy these sub-contractors were reputed to be. Even as use of online marketplaces became more common, structured mechanisms still did not exist to assist buyers with these issues. In effect, the process was still slow and inefficient due to the unstructured nature of subcontracting communication in complex multi-party transactions.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “rating” is a reference to one or more ratings and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a method of conducting a multi-level transaction includes receiving a primary call for proposals, publicizing the primary call for proposals, receiving one or more primary bids by a computing system with respect to the primary call for proposals, receiving one or more secondary calls for proposals for each primary bid, receiving one or more secondary bids by the computing system with respect to the one or more secondary calls for proposals, automatically determining an estimated cost of fulfillment for each primary bid, receiving a selection of a primary bid based on at least the estimated costs of fulfillment for the primary bids, and displaying the selection of the primary bid. Each secondary call for proposals includes a job request associated with the primary bid. The estimated cost of fulfillment is based on a cost of fulfillment associated with the primary bid and one or more secondary call costs of fulfillment.

In an embodiment, a system for conducting a multi-level transaction includes a processor in communication with an output device, and a computer-readable storage medium in communication with the processor. The computer-readable storage medium includes one or more programming instructions for receiving a primary call for proposals, publicizing the primary call for proposals, receiving one or more primary bids with respect to the primary call for proposals, receiving one or more secondary calls for proposals for each primary bid, receiving one or more secondary bids with respect to the one or more secondary calls for proposals, determining an estimated cost of fulfillment for each primary bid, and causing the selection of one of the one or more primary bids based on at least the estimated costs of fulfillment.

### BRIEF DESCRIPTION OF THE DRAWINGS

Aspects, features, benefits and advantages of the present application will be apparent with regard to the following description and accompanying drawings, of which:

FIG. 1 depicts a flow diagram of an exemplary method of conducting a multi-level transaction according to embodiment.

FIG. 2 is a block diagram of exemplary internal hardware that may be used to contain or implement program instructions according to an embodiment.

### DETAILED DESCRIPTION

The following terms shall have, for the purposes of this application, the meanings set forth below.

For the purposes of the discussion below, “multi-level transaction” refers to a recursive auction structure or other atomic transaction mechanism in which teams of service and/or product providers collaborate to connect and submit bids to a buyer within an online marketplace.

An “online marketplace” refers to a base marketplace system, base social network system and/or a collaborative marketplace system. The base marketplace system may include registered sets of users as buyers or sellers, an economic community database system maintaining profiles, data and transaction histories, posting mechanisms, guarantee and commission mechanisms, monitoring systems and qualification mechanisms in order to restrict bidding to specifically qualified providers. These base marketplace systems are commonly understood in the prior art. Examples of the base social network system would include sites such as LinkedIn, Facebook, elance.com, odesk.com and digg.com.

The “collaborative marketplace system” is a combination of a base marketplace system, a base social network system and additional features. For example, the collaborative marketplace system would integrate a base marketplace system and a base social network system and add additional features. The additional features may include a market database system for the base marketplace component augmented to allow individual calls for proposals to be associated in a tree-like structure. An additional database system may contain task breakdown structures associated with each call for proposals. Computational modules may retrieve individual ratings of users from the database and computing group ratings. Further, the modules may compute estimates of bids at stages of a recursive auction. Mechanisms may exist to forward calls for proposals along the social network automatically based on computed trust levels, and those trust levels may be updated based on marketplace transactional ratings.

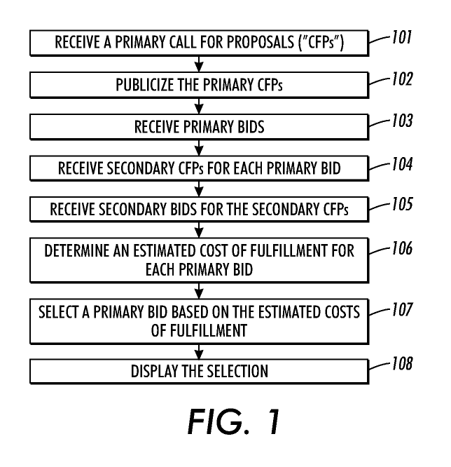

FIG. 1 depicts a flow diagram of an exemplary method of conducting a multi-level transaction according to an embodiment. As shown in FIG. 1, a primary call for proposals may be received 101, for example, from a user. The user may post the call for proposals directly or may contact marketplace personnel via an electronic device or a telecommunication device to have the call for proposals posted. Additional and alternate ways of posting a call for proposals are included within the scope of this disclosure. The primary call for proposals may pertain to a request for a service, one or more products and/or the like.

The primary call for proposals may be publicized 102. For example, a broadcast call may be provided generally. Alternately, an option to participate may be presented to one or more selected providers. In another embodiment, an auction notification may be provided through an automated alert system. In an embodiment, an auction notification may be provided through a qualifications engine. Additional and/or alternate ways of publicizing the primary call for proposals are included within the scope of this disclosure.

One or more primary bids with respect to the primary call for proposals may be received 103 by a computing system from users. For each primary bid, one or more secondary calls for proposals may be received 104 from users submitting primary bids. Each secondary call for proposals may include a job request associated with the primary bid. For example, if a primary call for proposals is for finishing a basement, a secondary call for proposals may be posted for drywall, electrical work, plumbing, and/or other services.

One or more secondary bids with respect to the one or more secondary calls for proposals may be received 105 by a computing system. The secondary bids may be received 105 from users who are sub-providers and/or sub-contractors. Additional and alternate forms of users may also be applicable. In an embodiment, one or more child calls for proposals may be received for each secondary bid. Each child call for proposals may include a job request associated with the secondary bid. One or more child bids with respect to the one or more child calls for proposals may be received by an computing system.

An estimate cost of fulfillment for each primary bid may be automatically determined 106. The estimate cost of fulfillment may be based on a cost of fulfillment associated with the primary bid and one or more secondary call cost of fulfillments. In an embodiment, a secondary call cost of fulfillment may be based on a cost of fulfillment associated with each secondary bid corresponding to a secondary call for proposals.

In an embodiment, an estimate of a retained portion may be received. One or more estimates associated with one or more winning bids for at least one secondary call for proposals may be received. Additionally, the estimated cost of fulfillment based on the estimate of the retained portion and the one or more estimates associated with the one or more winning bids for the at least one secondary call for proposals may be automatically determined.

In another embodiment, an estimate of a retain portion may be received. An average of one or more estimated costs associated with the one or more secondary bids may be received. The estimated cost of fulfillment based on the estimate of the retained portion and the one or more estimated costs associated with the one or more secondary bids may be determined.

In an embodiment, an estimate of a retained portion may be received. A maximum and minimum estimated cost of one or more estimated costs associated with the one or more secondary bids may be received. A range of the estimated cost of fulfillment may include a maximum cost and a minimum cost and may be automatically determined. The maximum cost may be a sum of the estimate of the retained portion and the maximum estimated cost for each secondary bid, and the minimum cost may be a sum of the estimate of the retained portion and the minimum estimated cost for each secondary bid.

In an embodiment, an adjustment to a secondary bid may be received. The estimated cost of fulfillment may be automatically adjusted based on the adjustment. A dynamic update of the estimated cost of fulfillment may be provided.

A primary bid may be selected 107 based on at least the estimated costs of fulfillment. One or more transactions based on the selected primary bid may be performed 108.

In an embodiment, a rejected bid from the one or more primary bids may be rejected. The rejected bid may be removed from the transaction. The rejected bid may further be reactivated.

Although the embodiment disclosed above with respect to FIG. 1 includes two or three levels, any plurality of levels may be included within the scope of this disclosure.

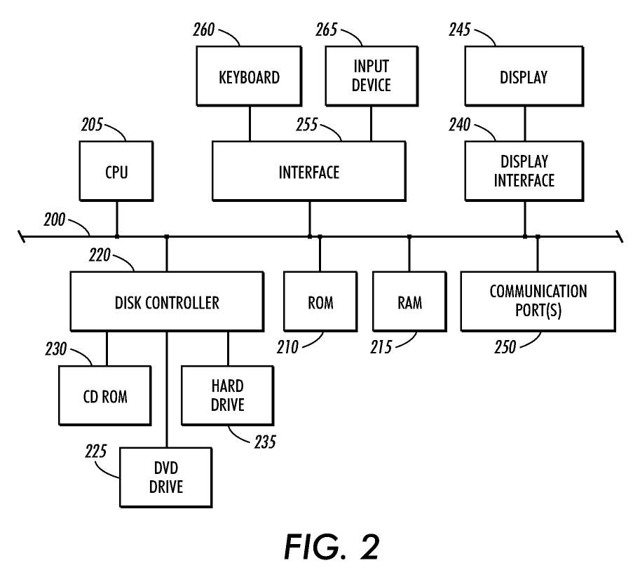

FIG. 2 depicts a block diagram of exemplary internal hardware that may be used to contain or implement program instructions according to an embodiment. A bus 200 serves as the main inform highway interconnecting the other illustrated components of the hardware. CPU 205 is the central processing unit of the system, performing calculations and logic operations required to execute a program. Read only memory (ROM) 210 and random access memory (RAM) 215 constitute exemplary memory devices or storage media.

An output device may communicate with the processor. Further, a computer-readable storage medium including one or more programming instructions may communicate with the processor. A disk controller 220 interfaces with one or more optional disk drives to the system bus 200. These disk drives may include, for example, external or internal DVD drives 225. CD ROM drives 230 or hard drives 235. As indicated previously, these various disk drives and disk controllers are optional devices.

Programming instructions may be stored in the ROM 210 and/or the RAM 215. Optionally, program instructions may be stored on any other tangible computer-readable storage medium, such as a hard drive, a compact disk, a digital disk, a memory or any other tangible storage medium.

An optional display interface 240 may permit information from the bus 200 to be displayed on a display 245 in audio, graphic or alphanumeric format. Communication with external devices may occur using various communication ports 250. Information detailing the one or more environmental footprint outputs may be displayed on an output device. In an embodiment, displaying such information may include causing the information to be displayed on printing devices, display devices and/or the like. Additional and/or alternate output devices may be utilized within the scope of this disclosure.

In addition to the standard computer-type components, the hardware may also include an interface 255 which allows for receipt of data from input devices such as a keyboard 260 or other input device 265 such as a mouse, remote control, pointer and/or joystick.

An embedded system may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

1. A method of conducting a multi-level transaction, the method comprising:
receiving a primary call for proposals pertaining to a job request;
publicizing the primary call for proposals;
receiving, by a computing system, one or more primary bids with respect to the primary call for proposals, wherein each primary bid corresponds to a provider;
for each primary bid;
receiving one or more secondary calls for proposals, wherein each secondary call for proposals includes a sub-job request associated with the primary bid;
receiving, by the computing system, one or more secondary bids with respect to the one or more secondary calls for proposals; wherein each secondary bid corresponds to a sub-provider, and
automatically determining, by the computing system, an estimated cost of fulfillment for each primary bid by:
receiving an estimate of a retained portion of the job request, wherein the retained portion is performed by the corresponding provider,
receiving an estimate associated with each winning bid for each secondary call for proposals, and
automatically determining the estimated cost of fulfillment based on the estimate of the retained portion and the estimate for each secondary call for proposals;
receiving a selection of a primary bid based on at least the estimated costs of fulfillment for the primary bids; and
displaying, on a display device, the selection of the primary bid.

2. The method of claim 1, wherein a secondary call cost of fulfillment is based on a cost of fulfillment associated with each secondary bid corresponding to a secondary call for proposals.

3. The method of claim 1, further comprising:
for each secondary bid, receiving one or more child calls for proposals, wherein each child call for proposals includes a job request associated with the secondary bid; and
receiving, by a computing system, one or more child bids with respect to the one or more child calls for proposals.

4. The method of claim I, wherein publicizing the primary call for proposals comprises providing a public broadcast call.

5. The method of claim 1, wherein publicizing the primary call for proposals comprises requesting participation from one or more selected providers.

6. The method of claim 1, wherein publicizing the primary call for proposals comprises providing an auction notification via an automated alert system.

7. The method of claim 1 wherein publicizing the primary call for proposals comprises providing an auction notification via a qualifications engine.

8. (canceled)

9. The method of claim 1, wherein determining an estimated cost of fulfillment comprises:
receiving an average of one or more estimated costs associated with the one or more secondary bids; and
determining the estimated cost of fulfillment based on the estimate of the retained portion and the one or more estimated costs associated with the one or more secondary bids.

10. The method of claim 1, wherein determining an estimated cost of fulfillment comprises:
receiving a maximum estimated cost of one or more estimated costs associated with the one or more secondary bids;
receiving a minimum estimated cost of one or more estimated costs associated with the one or more secondary bids; and
automatically determining a range of the estimated cost of fulfillment comprising a maximum cost and a minimum cost,
wherein the maximum cost comprises a sum of the estimate of the retained portion and the maximum estimated cost for each secondary bid, and
wherein the minimum cost comprises a sum of the estimate of the retained portion and the minimum estimated cost for each secondary bid.

11. The method of claim 1, further comprising:
receiving an adjustment to a secondary bid;
automatically adjusting the estimated cost of fulfillment based on the adjustment; and
providing a dynamic update of the estimated cost of fulfillment.

12. The method of claim 1, further comprising:
removing a rejected bid for a secondary bid from the one or more primary bids for the transaction.

13. The method of claim 12, comprising:
reactivating the rejected bid.

14. A system for conducting a multi-level transaction, comprising:
a processor in communication with an output device; and
a computer-readable storage medium in communication with the processor, wherein the computer-readable storage medium includes one or more programming instructions for:
receiving a primary call for proposals pertaining to a job request,
publicizing the primary call for proposals,
receiving one or more primary bids with respect to the primary call for proposals, wherein each primary bid corresponds to a provider,
for each primary bid:
receiving one or more secondary calls for proposals wherein each secondary call for proposals includes a sub-job request associated with the primary bid,
receiving one or more secondary bids with respect to the one or more secondary calls for proposals, wherein each secondary bid corresponds to a sub-provider,
determining an estimated cost of fulfillment for the primary bid by:
receiving an estimate of a retained portion of the job request, wherein the retained portion is performed by the corresponding provider,
receiving an estimate associated with each winning bid for each secondary call for proposals, and
automatically determining the estimated cost of fulfillment based on the estimate of the retained portion and the estimate for each secondary call for proposals, and
receiving a selection of one of the one or more primary bids based on at least the estimated costs of fulfillment.

15. (canceled)

16. (canceled)

17. The system of claim 14, wherein the one or more programming instructions for determining an estimated cost of fulfillment comprise one or more programming instructions for:
receiving an average of one or more estimated costs associated with the one or more secondary bids; and
determining the estimated cost of fulfillment based on the estimate of the retained portion and the one or more estimated costs associated with the one or more secondary bids.

18. The system of claim 14, wherein the one or more programming instructions for determining an estimated cost of fulfillment comprise one or more programming instructions for:
receiving a maximum estimated cost of one or more estimated costs associated with the one or more secondary bids;
receiving a minimum estimated cost of one or more estimated costs associated with the one or more secondary bids; and
automatically determining a range of the estimated cost of fulfillment comprising a maximum cost and a minimum cost,
wherein the maximum cost comprises a sum of the estimate of the retained portion and the maximum estimated cost for each secondary bid, and
wherein the minimum cost comprises a sum of the estimate of the retained portion and the minimum estimated cost for each secondary bid.

19. The system of claim 14, further comprising one or more programming instructions for:
automatically adjusting the estimated cost of fulfillment based on the adjustment; and
providing a dynamic update of the estimated cost of fulfillment.

20. The system of claim 14, further comprising one or more programming instructions for removing a rejected bid for a secondary bid from the one or more primary bids for the transaction.
